(19) United States
(12) Patent Application Publication
(10) Pub. No.: US 2011/0255617 A1
(43) Pub. Date: Oct. 20, 2011

(54) RADIO APPARATUS

(76) Inventors: Toshinori Suzuki, Fujimino-shi (JP); Satoshi Konishi, Fujimino-shi (JP); Toshihiko Komine, Fujimino-shi (JP)

(21) Appl. No.: 12/088,660

(22) Filed: Mar. 28, 2008

(30) Foreign Application Priority Data
Mar. 29, 2007 (JP) 2007-088978

(51) Int. Cl. H04L 27/28

(52) U.S. Cl. 375/260

(57) ABSTRACT

An in-phase component (I channel) and a quadrature component (Q channel) are interchanged between modulation symbols of an 8PSK system to be assigned to subcarriers of an OFDM system.

### BACKGROUND OF THE INVENTION

1. Field of the Invention

The present invention relates to a radio apparatus in which a multilevel Phase Shift Keying (PSK) system and an Orthogonal Frequency Division Multiplexing (OFDM) system are combined.

Priority is claimed on Japanese Patent Application No. 2007-088978, filed Mar. 29, 2007, the content of which is incorporated herein by reference.

2. Description of Related Art

Conventionally, a radio apparatus in which a multilevel PSK system and an OFDM system are combined is disclosed in, for example, Document 1 (Tomoya YAMAOKA, et al, “Compensation Scheme for Nonlinear Distortion with 8PSK/OFDM Transmission in Nonlinear Satellite Channel”, IEICE Transactions on Communications, vol. J90-B, no. 2, pp. 138-147, February 2007) and Document 2 (China Unicom, Huawei Technologies, KDDI, LG Electronics, Lucent Technologies, Motorola, Nortel Networks, QUALCOMM Incorporated, RITT, Samsung Electronics, and ZTE Corporation, “Joint Proposal for 3GPP2 Physical Layer for FDD Spectra”, 3GPP2 TSG-C WG3, C30-20060731-040, July 2006) and the like. For example, Document 1 discloses a radio apparatus in which an 8PSK system and an OFDM system are combined. FIG. 9 is a block diagram showing a part of a transmission system configuration of a conventional 8PSK/OFDM radio apparatus. In FIG. 9, an 8PSK modulator 11 maps an input transmission bit stream to a modulation symbol on a complex plane, and outputs a signal (I channel) of an in-phase component (I channel) and a signal (Q channel) of a quadrature component (Q channel) of the complex modulation symbol. A process is performed to convert the I and Q channels into OFDM symbols in different sequences in a similar fashion.

A serial to parallel converter 12a accumulates I channels of N modulation symbols and parallel outputs the I channel s of the N modulation symbols. N output ports No. 1 to No. N of the serial to parallel converter 12a are connected to N input ports No. 1 to No. N of an inverse discrete Fourier transformer (IFFT) 13a in this order. The input ports No. 1 to No. N of the IFFT 13a correspond to subcarriers SC₁ to SC_{N} of the OFDM system in order. Accordingly, the I channel output from the output ports No. 1 to No. N of the serial to parallel converter 12a are assigned to the subcarriers SC₁ to SC_{N} in order. The subcarriers SC₁ to SC_{N} are frequency sequences.

The IFFT 13a performs an inverse discrete Fourier transform operation on N number of the I channel s parallel input to the input ports No. 1 to No. N and generates and parallel outputs I-channel sample values of the N OFDM symbols. N output ports No. 1 to No. N of the IFFT 13a are connected to N input ports No. 1 to No. N of a parallel to serial converter 14a. The parallel to serial converter 14a serially outputs the N OFDM symbol sample values (I channel) parallel input to the input ports No. 1 to No. N in time sequence order. A Guard Interval (GI) inserter 15a inserts a guard interval into an OFDM symbol sample value stream (I channel). The OFDM symbol sample value stream (I channel) into which the guard interval has been inserted is converted from a digital signal into an analog signal by a digital to analog (D/A) converter 16a, and is input as an OFDM signal of the I channel to a combiner 17.

For Q channels like the I channels, an OFDM symbol sample value stream (Q channel) into which a guard interval has been inserted is created by respective sections 12b, 13b, 14b, and 15b, and is input as an OFDM signal of the Q channel to the combiner 17 after being converted into an analog signal by a D/A converter 16b. The combiner 17 performs a process for combining the OFDM signal of the I channel and the OFDM signal of the Q channel on the complex plane, and generates and outputs a complex OFDM signal. In the complex OFDM signal, I and Q channels of the same modulation symbol are assigned to the same subcarrier.

As described above, for example, the conventional multilevel PSK/OFDM radio apparatus disclosed in Documents 1 and 2 assigns I and Q channels of the same modulation symbol to the same subcarrier.

However, the above-described conventional multilevel PSK/OFDM radio apparatus has a problem in that demodulation performance is degraded by frequency selective fading. FIG. 10 is a conceptual view for explaining the effect of frequency selective fading of the conventional 8PSK/OFDM radio apparatus. In FIG. 10, eight complex modulation symbols are placed at equal intervals on the same circle in the complex plane configured from I and Q channels in a constellation (signal point placement) of 8PSK.

A transmitting side maps a complex modulation symbol to a subcarrier. At this time, I and Q channels of the same complex modulation symbol are mapped to the same subcarrier. Accordingly, the I and Q channels of the same complex modulation symbol are transmitted on the same subcarrier. A receiving side receives a signal of each subcarrier passed through a multi-path transmission channel, but the reception strength between subcarriers is different due to the effect of frequency selective fading. In an example of FIG. 10, the reception strength of a subcarrier SC_{N} is good, but the reception strength of a subcarrier SC₂ is weakened by the effect of frequency selective fading. Then, in a constellation of the subcarrier SC₂, the same circle in which reception points are placed on the complex plane is small as shown in FIG. 10. As a result, since the distance between reception points on the complex plane is shortened, it is weakened by noise, leading to the degradation of demodulation performance. The same problem may be caused even when the time variation of radio wave propagation characteristics occurs.

### SUMMARY OF THE INVENTION

The present invention has been made in consideration of the above situation and an object of the invention is to provide a multilevel PSK/OFDM radio apparatus that can promote an improvement of demodulation performance by preventing the degradation of demodulation performance due to the effect of frequency selective fading or the effect of time variation of radio wave propagation characteristics.

According to an aspect of the present invention for accomplishing an above-mentioned object, there is provided a radio apparatus in which a multilevel Phase Shift Keying (PSK) system and an Orthogonal Frequency Division Multiplexing (OFDM) system are combined, including: an in-phase component and a quadrature component configured to be interchanged between modulation symbols to be assigned to subcarriers of the OFDM system.

In the radio apparatus according to an aspect of the present invention, frequency intervals between the subcarriers, to which the in-phase component and the quadrature component of an identical modulation symbol are respectively assigned, are separated.

According to an aspect of the present invention, the radio apparatus further includes: a signal interchange section which interchanges the in-phase component and quadrature component between the modulation symbols; an observation section which observes frequency selective fading; and a control section which controls the signal interchange section based on an observation result.

According to an aspect of the present invention, there is provided a radio apparatus of a multilevel PSK system including: a section which stores an in-phase component and a quadrature component of an identical modulation symbol in temporally different radio frames.

The aspect of the present invention can promote an improvement of demodulation performance by preventing the degradation of demodulation performance due to the effect of frequency selective fading or the effect of time variation of radio wave propagation characteristics.

### BRIEF DESCRIPTION OF THE DRAWINGS

FIG. 1 is a block diagram showing part of a transmission system configuration of an 8PSK/OFDM radio apparatus according to a first embodiment of the present invention,

FIG. 2 is a block diagram showing part of a reception system configuration of the 8PSK/OFDM radio apparatus according to the first embodiment,

FIG. 3 is a conceptual view for explaining the effect of frequency selective fading according to the first embodiment,

FIG. 4 is a block diagram showing part of a transmission system configuration of an 8PSK/OFDM radio apparatus according to a second embodiment of the present invention,

FIG. 5 is a block diagram showing part of a reception system configuration of the 8PSK/OFDM radio apparatus according to the second embodiment,

FIG. 6 is a graph showing simulation results of bit error rate characteristics in a multi-path transmission channel according to the embodiments of the present invention,

FIG. 7 is a block diagram showing part of a transmission system configuration of an 8PSK/OFDM radio apparatus according to a third embodiment of the present invention,

FIG. 8 is a block diagram showing part of a reception system configuration of the 8PSK/OFDM radio apparatus according to the third embodiment,

FIG. 9 is a block diagram showing part of a transmission system configuration of a conventional 8PSK/OFDM radio apparatus, and

FIG. 10 is a conceptual view for explaining the effect of frequency selective fading of the conventional 8PSK/OFDM radio apparatus.

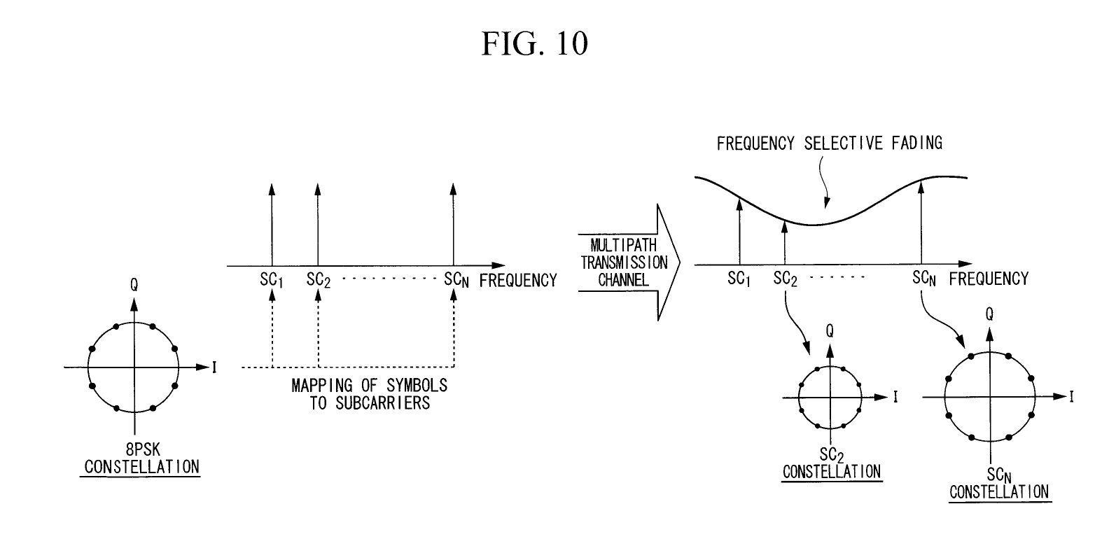

### DETAILED DESCRIPTION OF THE INVENTION

Hereinafter, embodiments of the present invention will be described with reference to the drawings.

### First Embodiment

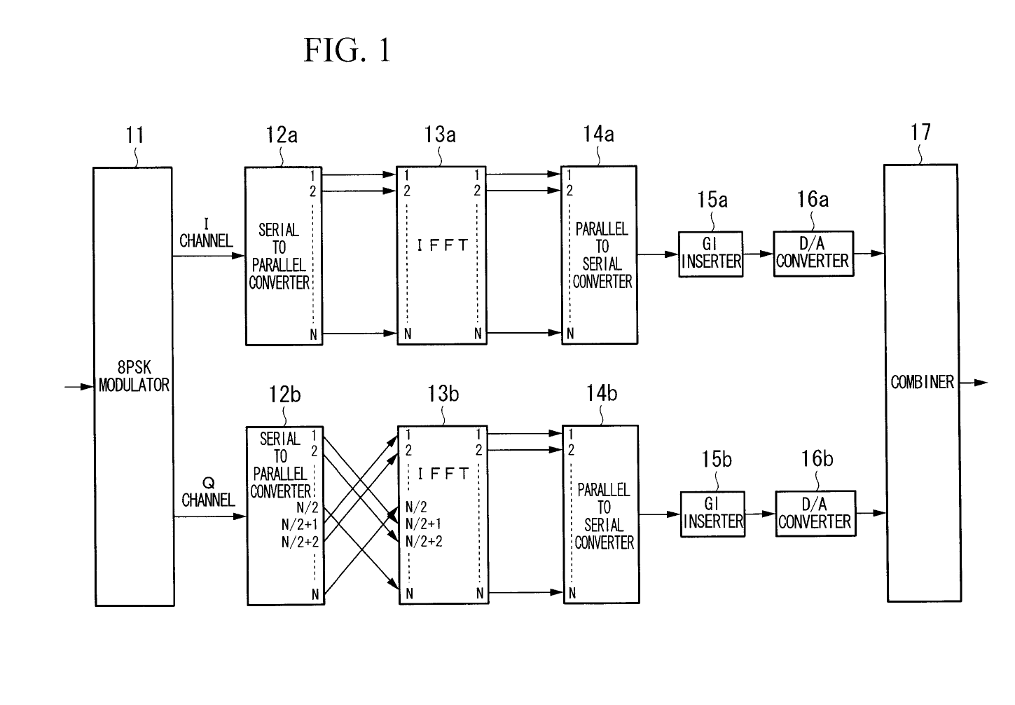

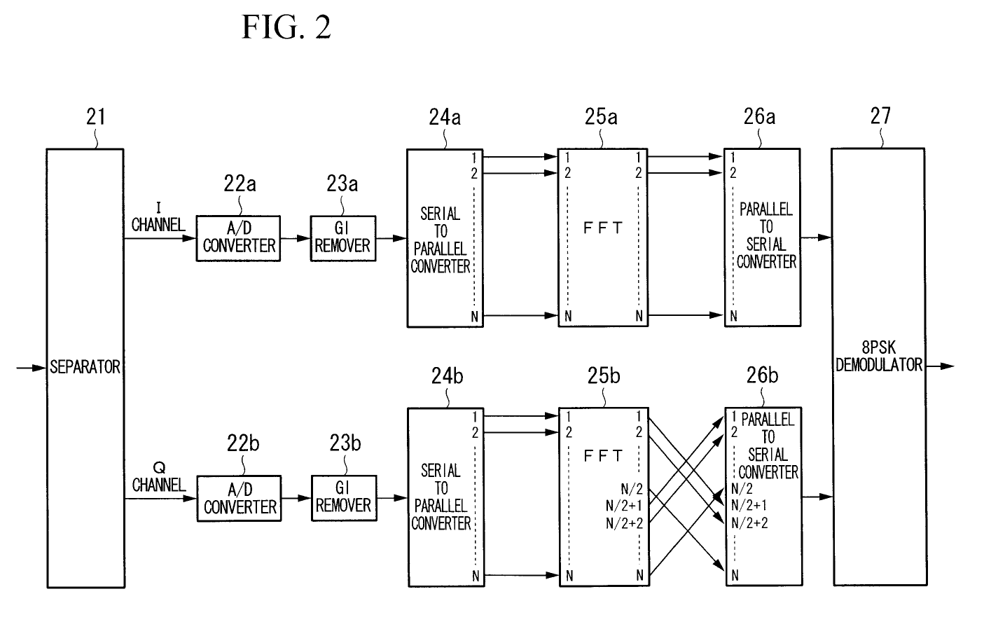

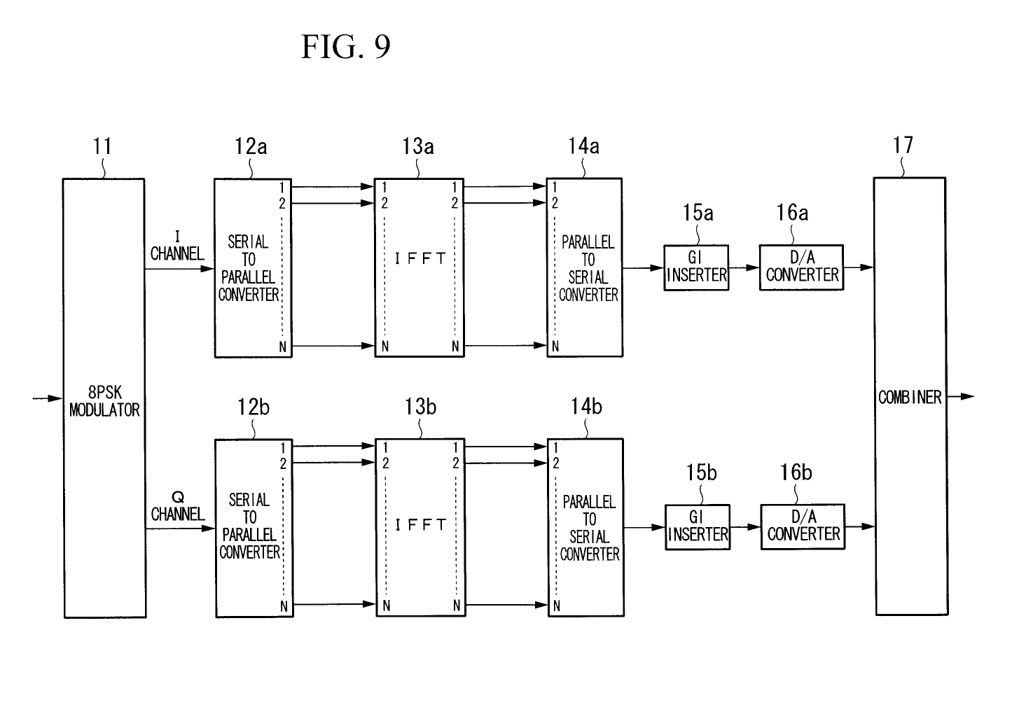

FIG. 1 is a block diagram showing part of a transmission system configuration of an 8PSK/OFDM radio apparatus according to a first embodiment of the present invention. FIG. 2 is a block diagram showing part of a reception system configuration of the 8PSK/OFDM radio apparatus according to the present embodiment. In FIG. 1, portions corresponding to those of FIG. 9 are assigned the same reference numerals.

First, the transmission system configuration according to the first embodiment of the present invention will be described with reference to FIG. 1. The 8PSK/OFDM radio apparatus shown in FIG. 1 is substantially the same as the conventional transmission system configuration of FIG. 9, but there is a difference in a configuration in which an in-phase component (I channel) and a quadrature component (Q channel) are interchanged between modulation symbols to be assigned to subcarriers of an OFDM system.

In FIG. 1, an 8PSK modulator 11 maps an input transmission information bit stream to a modulation symbol on a complex plane, and outputs I and Q channels of the complex modulation symbol. A process is performed to convert the I and Q channels into OFDM symbols in different sequences.

For the I channel as in the conventional transmission system configuration of FIG. 9, an OFDM symbol sample value stream (I channel) into which a guard interval has been inserted is created by a serial to parallel converter 12a, an IFFT 13a, a parallel to serial converter 14a, and a GI inserter 15a, and is input as an OFDM signal of the I channel to a combiner 17 after being converted into an analog signal by a D/A converter 16a.

On the other hand, for the Q channel, an OFDM symbol sample value stream (Q channel) into which a guard interval has been inserted is created by a serial to parallel converter 12b, an IFFT 13b, a parallel to serial converter 14b, and a GI inserter 15b. However, the subcarrier assignment method is different from that for the I channel. Hereinafter, a detailed configuration related to the Q channel will be described.

The serial to parallel converter 12b accumulates Q channels of N modulation symbols and parallel outputs the Q channels of the N modulation symbols. N output ports No. 1 to No. N of the serial to parallel converter 12b are connected to one of N input ports No. 1 to No. N of the IFFT 13b. In this regard, connections are different from those between the serial to parallel converter 12a and the IFFT 13a related to the I channels, and the connections can be totally or only partially different therefrom. In an example of FIG. 1, totally different connections are made.

The input ports No. 1 to No. N of the IFFTs 13a and 13b correspond to subcarriers SC₁ to SC_{N} of the OFDM system in this order. The subcarriers SC₁ to SC_{N} are a frequency sequence. For this reason, when the connections between the serial to parallel converter 12b and the IFFT 13b related to the Q channels are different from those between the serial to parallel converter 12a and the IFFT 13a related to the I channels, a subcarrier assignment method is changed in the I and Q channels. The I and Q channels between modulation symbols to be assigned to subcarriers can be interchanged for all the N modulation symbols or some of the N modulation symbols.

It is preferable that frequency intervals between subcarriers to which the I and Q channels of the same modulation symbol are assigned are not adjacent, but are as separated as possible. The reason is that a different effect of frequency selective fading can be expected as the frequency intervals are separated.

In the example of FIG. 1, the output ports No. 1 to No. N/2 of the serial to parallel converter 12b are connected to the input ports No. 1(N/2+1) to No. N of the IFFT 13b, and the output ports No. (N/2+1) to No. N of the serial to parallel converter 12b are connected to the input ports No. 1 to No. N/2 of the IFFT 13b. Accordingly, in the example of FIG. 1, the I and Q channels to be assigned to the subcarriers for all the N modulation symbols are interchanged and the frequency intervals between the subcarriers to which the I and Q channels of the same modulation symbol are assigned are maximally separated with respect to all the N modulation symbols.

The IFFT 13b performs an inverse discrete Fourier transform operation on N number of the Q channels parallel input to the input ports No. 1 to No. N and generates and parallel outputs Q-channel sample values of N OFDM symbols. An operation subsequent to the IFFT 13b is the same as that of the conventional transmission system configuration of FIG. 9. An OFDM symbol sample value stream (Q channel) into which a guard interval has been inserted is created by the parallel to serial converter 14b and the GI inserter 15b, and is input as an OFDM signal of the Q channel to the combiner 17 after being converted into an analog signal by a D/A converter 16b.

The combiner 17 performs a process for combining the OFDM signal of the I channel and the OFDM signal of the Q channel on the complex plane, and generates and outputs a complex OFDM signal. In this complex OFDM signal, the I and Q channels of the same modulation symbol are assigned to different subcarriers. In the example of FIG. 1, I and Q channels of all modulation symbols are assigned to different subcarriers.

Next, the reception system configuration according to the first embodiment of the present invention will be described with reference to FIG. 2. The reception transmission configuration of FIG. 2 corresponds to the transmission system configuration of FIG. 1.

In FIG. 2, a separator 21 performs a process for separating a received complex OFDM signal into I and Q channels on a complex plane, and outputs I and Q channels.

A process is performed to convert the I and Q channels into reception symbols in different sequences.

The I channel is digitally converted by an analog to digital (A/D) converter 22a, and is input to a serial to parallel converter 24a after removing a guard interval by a GI remover 23a. The serial to parallel converter 24a accumulates N reception sample values of the I channel of OFDM symbols output from the GI remover 23a, and parallel outputs the reception sample values (I channel) of the N OFDM symbols. N output ports No. 1 to No. N of the serial to parallel converter 24a are connected to N input ports No. 1 to No. N of a discrete Fourier transformer (FFT) 25a in this order.

The FFT 25a performs a discrete Fourier transform operation on the reception sample values (I channel) of the N OFDM symbols which are parallel input to the input ports No. 1 to No. N in parallel, generates I channels of the N reception symbols and output them in parallel. N output ports No. 1 to No. N of the FFT 25a are connected to N input ports No. 1 to No. N of a parallel to serial converter 26a in this order. The parallel to serial converter 26a serially outputs the I channels of the N reception symbols, which are input to the input ports No. 1 to No. N in parallel, to an 8PSK demodulator 27.

For the Q channel like the I channel, reception sample values (Q channel) of N OFDM symbols are created by respective sections 22b, 23b, and 24b and are input to an FFT 25b. The FFT 25b performs a discrete Fourier transform operation on the reception sample values (Q channel) of the N OFDM symbols which are input to the input ports No. 1 to No. N in parallel, and generates Q channels of the N reception symbols and outputs them in parallel. N output ports No. 1 to No. N of the FFT 25b are connected to one of N input ports No. 1 to No. N of a parallel to serial converter 26b. In this regard, connections are different from those between the FFT 25a and the parallel to serial converter 26a related to the I channels, and correspond to those between the serial to parallel converter 12b and the IFFT 13b of FIG. 1 of the transmitting side. Thus, the interchange of I and Q channels between modulation symbols of the transmitting side are recovered. The parallel to serial converter 26b serially outputs the Q channels of the N reception symbols, which are input to the input ports No. 1 to No. N in parallel, to the 8PSK demodulator 27.

The 8PSK demodulator 27 determines reception points based on the I and Q channels of the input reception symbols and outputs a reception bit stream.

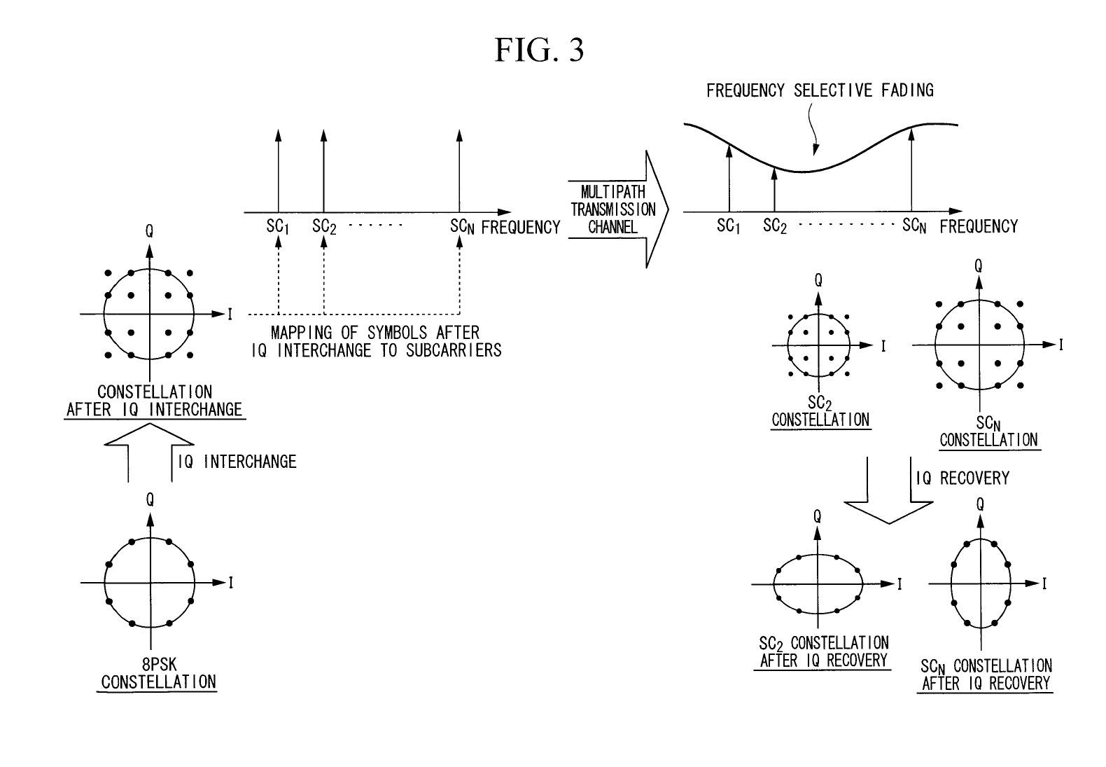

FIG. 3 is a conceptual view for explaining the effect of frequency selective fading according to the embodiment.

In FIG. 3, the transmitting side maps complex modulation symbols based on an 8PSK constellation to subcarriers of the OFDM system by interchanging I and Q channels between the complex modulation symbols. Accordingly, in this embodiment, I and Q channels of the same complex modulation symbol are transmitted on different subcarriers. FIG. 3 shows the 8PSK constellation and a constellation after the IQ interchange.

A receiving side receives a signal of each subcarrier passed through a multi-path transmission channel, but the reception strength between subcarriers is different due to the effect of frequency selective fading. In FIG. 3, the reception strength of the subcarrier SC_{N} is good, but the reception strength of the subcarrier SC₂ is weak due to the effect of frequency selective fading. Then, in a constellation of the subcarrier SC₂, the same circle in which reception points are placed on the complex plane is small as shown in FIG. 3. Herein, the I and Q channels are interchanged between the reception symbols in the receiving side and the I and Q channels of the reception symbols are recovered to a relation before interchanging the I and Q channels of the transmitting side, such that the constellation of the subcarrier SC₂ after IQ recovery can be obtained as shown in FIG. 3. In the constellation of the subcarrier SC₂ after the IQ recovery, eight complex modulation symbols are placed at equal intervals on an oval. Consequently, since a distance between reception points can increase on the complex plane, it is robust to noise, leading to an improvement in demodulation performance.

This embodiment as described above prevents the degradation of demodulation performance due to the effect of frequency selective fading, thereby promoting an improvement of the demodulation performance.

### Second Embodiment

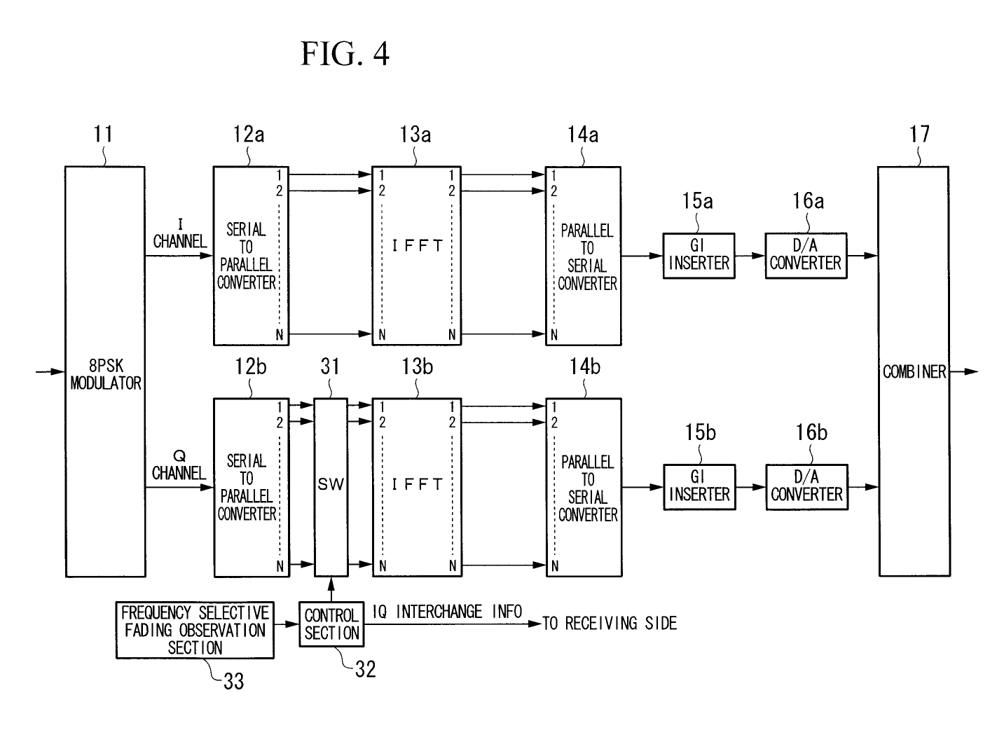

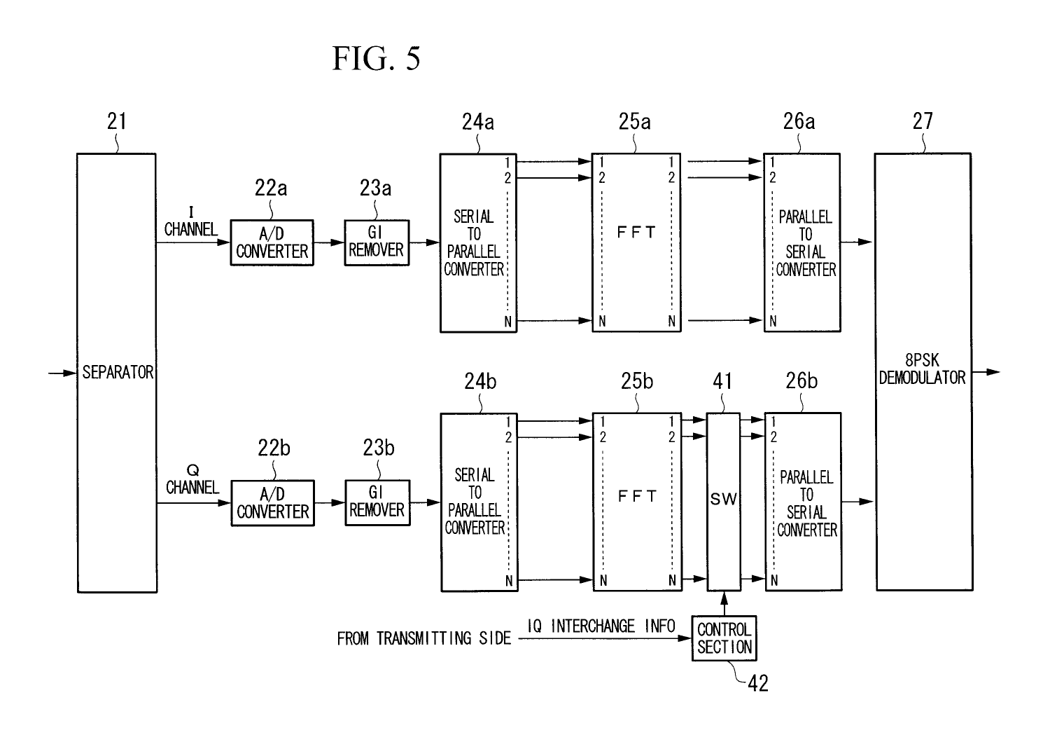

FIG. 4 is a block diagram showing part of a transmission system configuration of an 8PSK/OFDM radio apparatus according to a second embodiment of the present invention. FIG. 5 is a block diagram showing part of a reception system configuration of the 8PSK/OFDM radio apparatus according to the second embodiment. In FIGS. 4 and 5, portions corresponding to those of FIGS. 1 and 2 are assigned the same reference numerals and their description is omitted.

In the transmission system configuration of the second embodiment in FIG. 4, an N×N switch 31 is provided between a serial to parallel converter 12b and an IFFT 13b related to Q channels. Accordingly, a connection between the serial to parallel converter 12b and the IFFT 13b can be made arbitrarily. A control section 32 controls the switch 31. A frequency selective fading observation section 33 observes frequency selective fading.

The control section 32 determines a connection method between the serial to parallel converter 12b and the IFFT 13b based on the result of observation by the frequency selective fading observation section 33. Accordingly, I and Q channels can be interchanged according to a frequency selective fading state. The control section 32 sends interchange information of the I and Q channels (IQ interchange information) to the receiving side.

In the reception system configuration of the second embodiment in FIG. 5, an N×N switch 41 is provided between an FFT 25b and a parallel to serial converter 26b related to Q channels. Accordingly, a connection between the FFT 25b and the parallel to serial converter 26b can be made arbitrarily. A control section 42 controls the switch 41 according to IQ interchange information sent from the transmitting side.

The above-described second embodiment can interchange I and Q channels according to a frequency selective fading state.

The receiving side can observe the frequency selective fading to send its result to the transmitting side. In this case, the receiving side can determine a method for interchanging I and Q channels according to a frequency selective fading state to send IQ interchange information to the transmitting side. In the case of a Time Division Duplex (TDD) system, the same frequency is used in both directions of a radio transmission, such that the frequency selective fading can be observed in any side of the transmitting side or the receiving side.

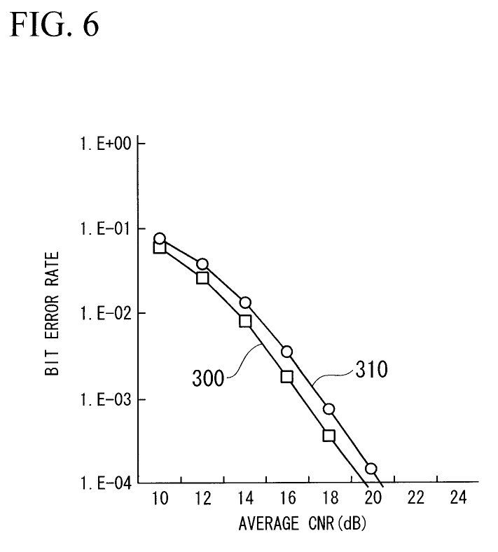

FIG. 6 is a graph showing simulation results of bit error rate characteristics in a multi-path transmission channel according to the embodiments of the present invention. In FIG. 6, the horizontal axis represents a Carrier to Noise power Ratio (CNR) and the vertical axis represents a bit error rate.

In simulation conditions, the multi-path model was Pedestrian-B, the information bit length was 1440, the coding scheme was turbo coding and Max-log-MAP decoding, the coding rate was ¾, the FFT size was 512 points, the total number of subcarriers was 480, the number of used subcarriers was 80 (assignment in a unit of 6 subcarriers), the interval between subcarriers was 15 kHz, and the guard interval length was 6.5 μS.

The method for interchanging I and Q channel assigned to subcarriers was random.

In FIG. 6, a waveform 300 is a simulation result of a bit error rate characteristic according to the embodiments of the present invention, and a waveform 310 is a simulation result of a conventional bit error rate. As is apparent from FIG. 6, the embodiments of the present invention can achieve a better bit error rate characteristic than that of the conventional technique. Even when distances between subcarriers to which I and Q channels are assigned are maximized or maintained at equal intervals as shown in FIG. 1 described above, simulation results substantially equal to those of FIG. 6 can be achieved.

### Third Embodiment

A third embodiment deals with time variation of radio wave propagation characteristics. This method can be realized by applying a method for dealing with the above-described frequency selective fading. In a method for dealing with the frequency selective fading, a frequency distance is taken such that I and Q channels of the same modulation symbol are assigned to different subcarriers and propagated. However, in this embodiment, the I and Q channels of the same modulation symbol are stored in temporally different radio frames, and the time distance of propagation time points is taken. Accordingly, an improvement of the constellation as shown in FIG. 3 can be promoted.

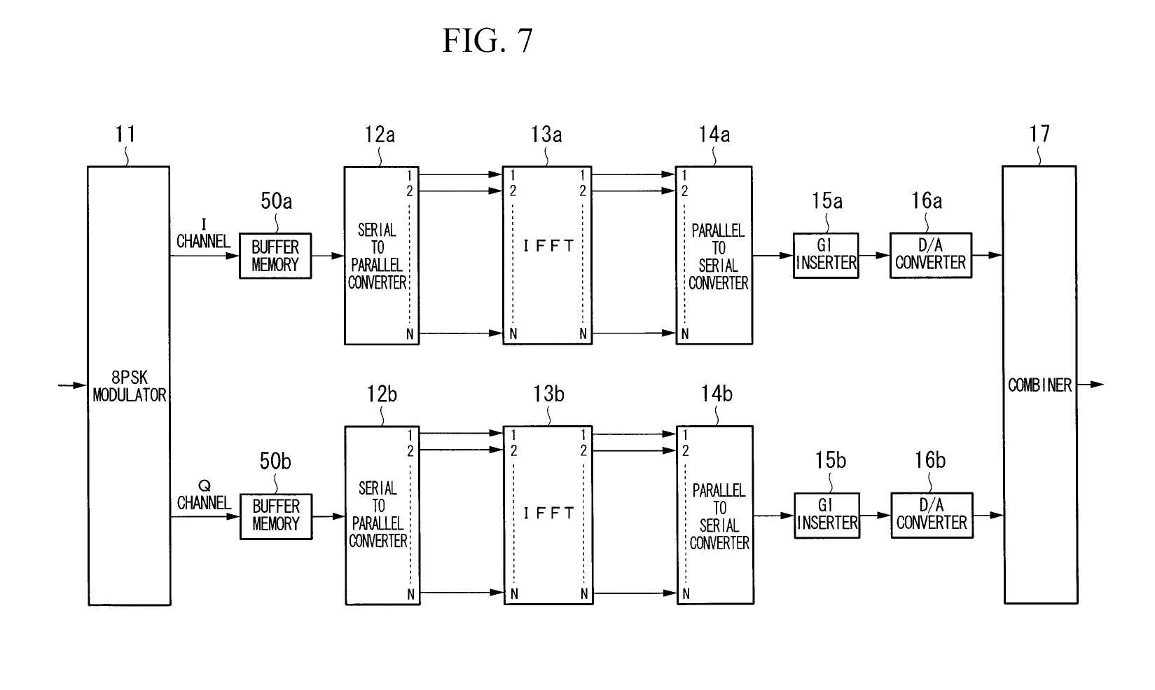

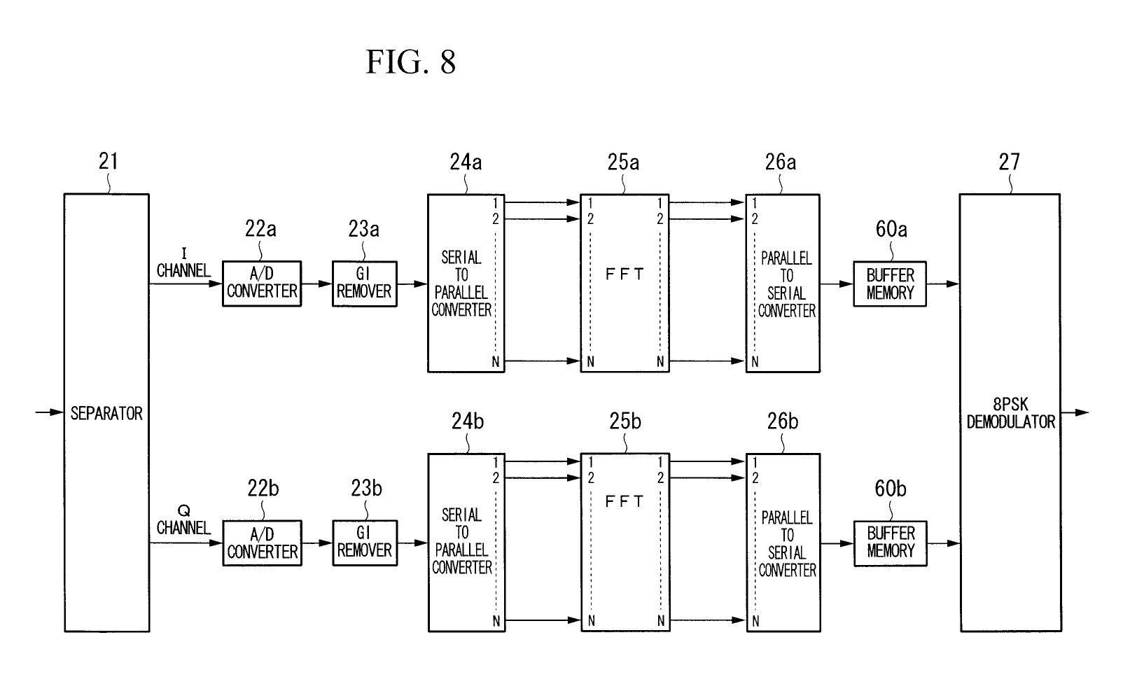

FIG. 7 is a block diagram showing part of a transmission system configuration of an 8PSK/OFDM radio apparatus according to a third embodiment of the present invention. FIG. 8 is a block diagram showing part of a reception system configuration of the 8PSK/OFDM radio apparatus according to the embodiment.

In FIG. 7, the 8PSK/OFDM radio apparatus according to this embodiment is substantially the same as the conventional 8PSK/OFDM radio apparatus shown in FIG. 9, but buffer memories 50a and 50b are respectively provided between an 8PSK modulator 11 and serial to parallel converters 12a and 12b. The buffer memories 50a and 50b respectively accumulate signals output from the 8PSK modulator 11 (that is, the buffer memory 50a accumulates I channels and the buffer memory 50b accumulates Q channels). An accumulation amount corresponds to at least one radio frame. When signals are read from the buffer memories 50a and 50b, a read method is changed such that I and Q channels of the same modulation symbols are stored in different radio frames in an I channel side and a Q channel side. For example, a read operation from the buffer memory 50a is performed in a first-in and first-out scheme and a store operation in a radio frame is performed in an output order from the 8PSK modulator 11. On the other hand, a read operation from the buffer memory 50b is performed in a FIFO (first-in and first-out) scheme, and a store operation in a radio frame is performed in a reverse output order from the 8PSK modulator 11 in a radio frame unit. Accordingly, the I and Q channels of the same modulation symbol are stored in temporally different radio frames and are propagated according to a time interval.

The reception system configuration of FIG. 8 corresponds to the transmission system configuration of FIG. 7 and is substantially equal to the conventional 8PSK/OFDM radio apparatus, but buffer memories 60a and 60b are respectively provided between parallel to serial converters 26a and 26b and an 8PSK demodulator 27. The buffer memories 60a and 60b correspond to the buffer memories 50a and 50b of the transmitting side of FIG. 7, and are used to recover the interchange of I and Q channels stored in radio frames in the transmitting side. The buffer memories 60a and 60b respectively accumulate signals output from the parallel to serial converters 26a and 26b.

An operation for reading signals from the buffer memories 60a and 60b originally returns the reverse order at the time of reading from the buffer memories 50a and 50b. Accordingly, the interchange of I and Q channels in the transmitting side is recovered.

According to this embodiment, the receiving side receives a signal of each radio frame passed through a radio wave channel having time variation of radio wave propagation characteristics, but reception strengths between radio frames are different due to the effect of time variation of radio wave propagation characteristics. For example, even when the reception strength of a radio frame Fr1 of a certain time is good, the reception strength of a radio frame Fr2 of a different time is weak due to the effect of time variation of radio wave propagation characteristics. Then, in a constellation of the radio frame Fr2 like the constellation of the subcarrier SC₂ shown in FIG. 3, the same circle in which reception points are placed on the complex plane is small. Herein, the receiving side recovers original time sequences before the interchange of the transmitting side for time sequences of I and Q channels, such that a constellation in which eight complex modulation symbols are placed at equal intervals on an oval can be obtained like the constellation of the subcarrier SC₂ after IQ recovery shown in FIG. 3. Consequently, since the distance between reception points can increase on the complex plane, it is robust to noise, leading to an improvement in demodulation performance.

The above-described third embodiment is not limited to a multi-carrier system such as an OFDM system or the like, and can be applied to a radio apparatus of a single carrier system.

While preferred embodiments of the invention have been described and illustrated above, it should be understood that these are exemplary of the invention and are not to be considered as limiting. Additions, omissions, substitutions, and other modifications can be made without departing from the spirit or scope of the present invention.

For example, the assignment to subcarriers of Q channels or a time sequence is changed in the above-described embodiment, but I channels can be changed.

Means for interchanging I and Q channels of modulation symbols assigned to subcarriers of the OFDM system is not limited to the above-described embodiment. For example, an interleaver for permuting a bit stream to be arranged can be used.

An Amplitude Phase Shift Keying (APSK) system is a type of PSK system, and the present invention can be equally applied to a multilevel APSK system.

What is claimed is:

1. A radio apparatus in which a multilevel Phase Shift Keying (PSK) system and an Orthogonal Frequency Division Multiplexing (OFDM) system are combined, comprising:
an in-phase component and a quadrature component configured to be interchanged between modulation symbols to be assigned to subcarriers of the OFDM system.

2. The radio apparatus according to claim 1, wherein the in-phase component and the quadrature component of an identical modulation symbol are respectively assigned to the subcarriers, and frequency intervals between the subcarriers are separated.

3. The radio apparatus according to claim 1, further comprising:
a signal interchange section which interchanges the in-phase component and quadrature component between the modulation symbols;
an observation section which observes frequency selective fading; and
a control section which controls the signal interchange section based on an observation result.

4. A radio apparatus of a multilevel PSK system comprising:
a section which stores an in-phase component and a quadrature component of an identical modulation symbol in temporally different radio frames.
